(19) United States
(12) Patent Application Publication
(10) Pub. No.: US 2003/0217032 A1
(43) Pub. Date: Nov. 20, 2003

(54) System and method for providing business strategy and compliance information

(76) Inventors: Dick Fritzler, Las Vegas, NV (US); Richard Fritzler II, Las Vegas, NV (US)

Correspondence Address: WEIDE & MILLER, LTD., 7251 W. LAKE MEAD BLVD., SUITE 530, LAS VEGAS, NV, 89128, US

(21) Appl. No.: 10/150,592

(22) Filed: May 16, 2002

(51) Int. Cl. G06F 7/00

(52) U.S. Cl. 707/1

(57) ABSTRACT

A system includes a host computer, a records database and module for generating and storing business-related records in electronic form, a forms database and module for providing forms in electronic format and accepting user input to complete forms, an information database and graphical user interface for accessing information in the database, and a calendaring database and module for generating calendar dates for events and transmitting reminders, and a communication interface permitting remote users to access the system and access the information, forms, records and calendaring information/functions. In one embodiment, the stored information pertains to business strategy information, including tax planning, corporate and business entity strategy, formation, compliance and the like. Users are assigned to categories determining which information/functions are accessible to the user. One method comprises certifying certain users to provide services for others. The invention is a single-source point of access for comprehensive business and tax planning and compliance.

### FIELD OF THE INVENTION

The present invention relates to a system and method for providing information, and more particularly business strategy and compliance information such as corporate and tax strategy and filing information.

### BACKGROUND OF THE INVENTION

Businesses employ a wide variety of tactics to improve their profitability. One significant factor upon the profitability of a business is the expense of taxes. Generally, a business will utilize an accountant or tax preparer to prepare income tax and related statements for determining the amount of certain taxes which are owed. The accountant will attempt to utilize information provided by the business and apply the information as favorably as possible, within the bounds of the law, to reduce the total amount of taxes owed. In this arrangement, however, the business operates through a fiscal year and the account simply utilizes the “after the fact” event information to determine the amount of taxes which are due.

In many instances, when a business is formed the business may take into consideration issues such as the form of the entity which will do business in an attempt to capitalize on certain benefits realized by different forms of business entities. For example, a business may incorporate as a corporation to take advantage of the limited liability aspects of corporate status. A business may also choose a particular form of entity in an attempt to limit taxation. For example, a business may incorporate as a limited liability corporation or “S” corporation to avoid taxation at both the corporate and individual level.

Generally, the choice of the form of business entity is determined by the business owner in conjunction with a business planner, corporate attorney or the like. Further, this choice is generally made at the time the business is formed. After the business is formed, it generally does business, filing tax returns in the manner described above. This model of doing business, however, has several disadvantages.

One problem relates to the fact that many businesses are not provided with information regarding how to conduct business before the fiscal year begins so that the most advantageous tax reducing strategy is employed. As indicated, most businesses do business during the year and then their transaction data is manipulated after the fact in an attempt to limit taxes owed. If the business as provided with planning information ahead of time, actions could pro-actively be taken to limit the total tax liability which the business would incur.

Another problem is that the business may not obtain any information regarding certain business activities which might be employed to reduce total tax or provide other business advantages because they are not known to the tax preparer. For example, a particular business might find that by incorporating a portion of its operations as a separate corporate entity, significant tax and liability avoidance gains might be realized. However, these strategies may only be known to the business' corporate attorney who is not consulted on an annual basis like the business' tax preparer or accountant.

Yet another problem is that once the business entity is established, a number of ongoing requirements must be satisfied in order to maintain the business entity. For example, in the case of a corporation, certain minutes must be kept, annual filings such as a list of corporate officers and the like may also be required to be filed in order to maintain the corporation in good standing. If these actions are not taken, the advantages of the corporate or other status, such as limited liability, may be negated. Commonly, while a corporate planner or corporate attorney are utilized to form the company, once the company is formed these later activities are left to personnel at the company. For example, a secretary at the business may be charged with preparing and filing the necessary papers. Because the person assigned is generally not skilled in these activities, they are often not completed, not completed on time or are completed incorrectly.

Some larger companies hire specific personnel for the purpose of preparing these necessary papers. Still, however, these personnel and the business' tax preparer or accountant usually work independent from one another, and the cost to the business is significant. Further, even these personnel often do not have access to all of the ever-changing information regarding tax law, corporate law and the like which might aid them in fulfilling their duties for the business.

A system and method for providing businesses with comprehensive and up-to-date business strategy information, including tax, corporate and other planning information, is desired. A system and method for providing businesses with tax, corporate and other compliance information is also desired.

### SUMMARY OF THE INVENTION

The invention comprises various methods and systems for providing comprehensive business strategy and related information, such as tax and corporate planning information, forms, electronic records and calendaring information. As one aspect of the invention, a system and method are particularly arranged to provide tax and business information specifically for use in employing business strategies for limiting liability and the amount of taxes owed.

In one embodiment of the invention, the system includes a host comprising at least one computing device configured to execute machine readable code to perform various functions. The system also includes an information database associated with the host, the information database containing business strategy information associated with the host. Preferably, the business strategy information comprises information regarding tax planning, choice of business entity and corporate and related planning information, as well as general tax and business information such as codes, laws, court decisions, articles, tips, flowcharts, checklists and the like. In a preferred embodiment, the information includes specific information for implementation in business strategy for limiting the amount of incurred taxes.

The system also includes a records database associated with the host. The records database contains business records in electronic format. In one embodiment, the system includes a records module for providing access to records in the database and generating or altering records and storing them in the records database.

The system includes a forms database associated with the host. The forms database contains forms in electronic format. In one embodiment, the system includes a forms module for providing access to a form in the forms database, accepting the input of information and inputting the information into the form to complete the form.

The system includes a calendaring module associated with said host for generating calendar dates and reminders regarding calendar dates and a calendaring database associated with the host for storing calendar dates.

In one embodiment, the system includes a user identification module associated with the host for use in identifying a user and a status of the user, the status of the user determining the user's access to portions of said system such as the information database, records database and forms database.

In one embodiment, a communication interface is associated with the host, permitting information to be received by the host from a remotely located user via a communication link and permitting information to be transmitted from the host to the user.

In one embodiment, the system includes a graphical user interface. The graphical user interface may be generated by the host and is transmitted to the user. In one embodiment, the format of the graphical user interface depends upon the status of the user. The graphical user interface provides an interface for the user to access various portions of the system, including implementing various functions which may be performed using the system.

One embodiment of a method of the invention comprises providing business strategy and related business information to a user. In one embodiment, information is provided using a system, with the user accessing business strategy information from an electronic database of stored information.

In one embodiment of a method, a user is permitted to access one or more forms stored in electronic format. The user may input information to complete the form and then have the form electronically transmitted, printed and/or stored.

In one embodiment of a method, a user is permitted to generate and store records, such as tax returns and filings and corporate records. The records are stored in electronic form, permitting the user to also access the records, such as for printing or transmittal.

A user may also be permitted to input event information and have calendar information regarding future events be generated and stored. The method includes the step of generating reminders regarding future events from the stored information and transmitting the reminder to the user.

In one embodiment, a method also includes the step of providing live classroom training to a user to educate the user regarding business strategy information in the areas of tax and business entity planning.

In one embodiment of a method of using a system, one or more users must subscribe in order to gain access to the system. Each user is assigned to a particular user category. In one embodiment, there are three user categories. Each user category is defined by a particular set of functions or features of the system to which the user is permitted access. In one embodiment, certain categories of users are not permitted to access all features or functions of the system.

In one embodiment, when a user subscribes, a user profile is created, the user profile including an identification of the category or status of the user. When the user accesses the system, they are required to identify themselves, such as with a password.

One embodiment of a method of the invention comprises certifying a user to provide services to others. In one embodiment, a user is required to take live classroom training and meet certain requirements, such as continued education and compliance with testing or other requirements to be certified and maintain certification. If certified, a user may utilize a system of the invention to generate and store information for clients, such as corporate and tax records for a business. The user may also utilize the system to generate calendar information for each client.

In general, the methods and systems of the invention provide a single source for comprehensive business strategy and related information and functions. For example, a business is provided with a single source for information regarding a variety of business topics including tax planning and corporate compliance. The same source also provides a location for the business to obtain required business-related forms, such as tax or corporate forms. These forms may be generated and then stored remotely. Further, the same source generates calendar dates and provides reminders to the business of dates by which certain actions must be taken. The “same source” availability eliminates the need for the business to seek independent in-house and out-of-house resources to obtain the same information and perform the same tasks. Further, the cost of this information and the various functions can be provided at a much lower cost than if the information and services were to be obtained independently.

Further objects, features, and advantages of the present invention over the prior art will become apparent from the detailed description of the drawings which follows, when considered with the attached figures.

### DESCRIPTION OF THE DRAWINGS

FIG. 1 schematically illustrates one embodiment of a system of the invention;

FIG. 2 illustrates one embodiment of a host of the system illustrated in FIG. 1;

FIG. 3 is a flow diagram illustrating a method of the invention;

FIG. 3A is a flow diagram illustrating an embodiment of a step of signing up for service or system usage in accordance with a first step of the method illustrated in FIG. 3; and

FIG. 3B is a flow diagram illustrating one embodiment of a step of providing access to a system of the invention in accordance with a second step of the method illustrated in FIG. 3.

### DETAILED DESCRIPTION OF THE INVENTION

The invention is a system and method for providing access to business strategy and compliance information. In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

In general, the present invention comprises a system and method of providing business strategy and related information. As described below, this information may comprise tax planning and corporate planning information. One aspect of the invention comprises a system and method of providing business compliance information, such as information regarding corporate compliance. This information includes forms and filing deadlines. Another aspect of the invention comprises a system and method for certifying certain personnel to provide business strategy and related information.

In one embodiment, the invention comprises a business information access system. As described below, this system may have a variety of configurations. In one embodiment, the system includes components for generating and configuring information, as well as providing information to users of the system, including users located remotely from the system. In one embodiment of the system, the system is configured to discriminate between types of users, providing different “levels” of information dependent upon a status of the user of the system.

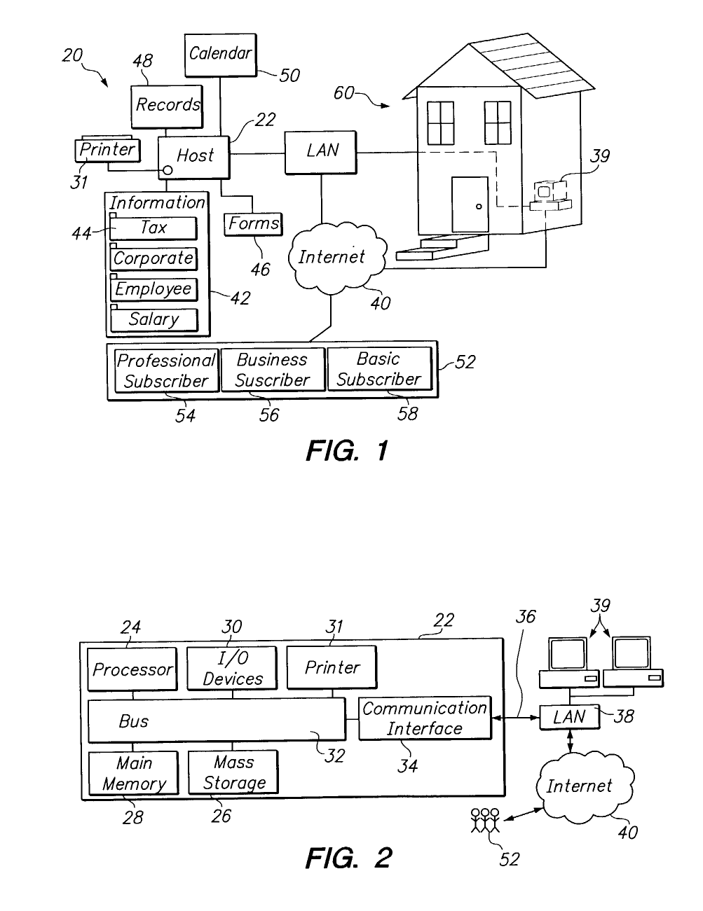

One embodiment of a business information access system 20 is illustrated in FIG. 1. As illustrated, the system 20 includes a host 22. In one embodiment, the host 22 comprises one or more computing devices capable of executing computer readable program code, such as for generating an output in response to an input.

One embodiment of the host 22 is illustrated in FIG. 2. As illustrated therein, the host 22 includes a processor or processing device 24 having the capability of executing the computer readable program code. In one embodiment of the invention, the processor 24 is a microprocessor manufactured by Sun Microsystems, Inc., such as the SPARC™ microprocessor, or a microprocessor manufactured by Motorola, such as the 680×0 processor, or a microprocessor manufactured by Intel, such as the 80×86, or Pentium processor. However, any other suitable microprocessor or microcomputer may be utilized.

In a preferred embodiment, the host 22 includes one or more data storage devices for storing, either temporarily or over a long period of time, data. The types of data which may be stored will be described in detail below.

In a preferred embodiment, the data storage device includes a main memory 28 which provides for high speed data access. In one embodiment, the main memory 28 may comprise readonly-memory (ROM), or any of a variety of data storage and access devices such as static RAM, Dynamic RAM, Synchronous Dynamic RAM, RD RAM and FLASH ROM.

In one embodiment, the data storage device also includes at least one data mass storage 26. As is well known, the mass storage device 26 may comprise a wide variety of devices and mediums capable of storing electronic data, such as a hard drive, CD-ROM, DVD-ROM, floppy disc, tape or the like.

In a preferred embodiment the host 22 has appropriate input/output controllers and devices 30. The input/output devices 30 may comprise a number of devices for accepting information from a user and outputting information to a user. The input devices 30 may include one or more keyboards, keypads, a mouse, a touch screens and other devices. The output devices 30 may include CRT's, LCDs and other devices. One specific output device which may be provided is a printer 31. The printer 31 may be of a variety of types, including laser and dot-matrix.

The host 22 includes means permitting data to be transmitted between and among the various components. In one or more embodiments, this means comprises a system bus 32. The system bus 32 may comprise, for example, a 64-bit data bus for transferring data between and among the components, such as the processor 24, the mass storage 26, the main memory 28, the input/output devices 30 and the printer 31.

In this configuration, the host 22 is capable of generating information and storing information. The host 22 is also capable of accepting input from various input devices directly associated with the host 22, such as a station including a keyboard, mouse and display screen. The host 22 is also capable of outputting information to a user, such as to the station including the display screen.

It is preferred, however, that users be permitted to interact with the host 22 from a variety of remote locations. Thus, in accordance with one embodiment of the invention, the host 22 is associated with a network. The host 22 preferably includes a communication interface 34 which is coupled to the system bus 32. The communication interface 34 provides a two-way data communication coupling via a network link 36 to a local network 38. The communication interface 34 may have a variety of architectures and utilize a variety of protocols such as IEEE-1394 (FireWire™) or Ethernet in the case where the link 36 is a wired link, or 802.11 b or Bluetooth™ in the case of a wireless link. In any such implementation, the communication interface 34 sends and receives electrical, electromagnetic or optical signals which carry digital data bit, packets or streams representing various types of information.

The network link 36 preferably provides a communication path to a local network or LAN 38. A variety of devices may be associated with the LAN 38. For example, a plurality of user stations 39 may be associated with the LAN 38. Though not illustrated in detail, these user stations 39 may comprise workstations, laptops, or handheld devices which include input and output components, such as display screens and keypads or keyboards.

The network link 36 may provide data communication through one or more networks to other data devices. For example, the network link 36 may provide a connection through the local network 38 to a local server computer or to data equipment operated by an Internet Service Provider (ISP). The ISP may in turn provide data communication services through the world wide packet data communication network now commonly referred to as the “Internet” 40. The local network 38 and Internet 40 both use electrical, electromagnetic or optical signals which carry digital data in bits, streams or packets.

In accordance with this configuration of the system 20 of the present invention, a remotely located user may access information associated with the system via the Internet 40. Various methods of the invention which may be implemented using a system such as the system 20 illustrated are described in more detail below.

Referring to FIG. 1, in one embodiment of the invention the host 22 is associated with a plurality of databases. It will be understood that these databases may comprise data mass storage devices such as the device 26 illustrated in FIG. 2. The databases may also comprise other independent devices. These independent devices may even comprise individual computing devices having associated processors.

In one embodiment, the system 20 includes a general business information database 42. The information database 42 in a preferred embodiment stores business strategy and related information or data that may be accessed by a user of the system 20. As illustrated in FIG. 1, in one or more embodiments the information or data stored in the information database 42 is configured into files 44. These files 44 may be identifiable by the subject matter/information that they store. For example, as illustrated, there is a tax information file, a corporate information file, an employee manual file, a safety manual file, and others. It will be appreciated that in one or more embodiments the information database 42 may contain more or less files than those illustrated, and each file may contain sub-files. The data may also be arranged in other formats, such in folders containing files and the like.

In one embodiment, the system 20 includes a forms database 46. The forms database 46 may be similarly configured to the information database 42. In a preferred embodiment, however, the forms database 46 includes files containing information regarding specific forms or templates, the purpose and use of which will be described in more detail below.

In one embodiment, the system 20 includes a records database 48. The records database 48 may be similarly configured to the information database 42. In a preferred embodiment, however, the records database 48 includes files containing information regarding already created corporations and other records belonging to a user of the system 20.

In one embodiment, the system 20 includes a calendaring database 50. The calendaring database 50 may be similarly configured to the information database 42. In a preferred embodiment, however, the calendaring database 50 includes files containing information regarding specific dates by which specific activities are to occur.

These databases 42,46,48,50 may be part of the same physical storage or other device, or be separate, as described above. Generally, however, these databases 42,46,48,50 store information which is utilized by the host 22 in providing information to users or for storing information which is generated by the host 22.

As illustrated in FIG. 1, a variety of users 52 may be permitted to access the host 22. In one embodiment, and as described in more detail below, these users 52 may be categorized. In the embodiment illustrated, the users 52 may comprise professional level subscribers 54, business level subscribers 56, and basic level subscribers 58.

In one embodiment, the system 20 of the invention may include one or more classrooms 60. The classroom 60 may be at any of a variety of physical locations, including a hotel conference room, dedicated class training room or the like. In one embodiment, the classroom 60 is linked to the host 22 either by a station 39 which is part of the local area network 38 of the system 20, or which is in communication with the host 22 via another communication link, such as via the Internet 40.

A variety of methods of the invention will now be described. In many instances, the methods will be described with reference to the system 20 illustrated in FIG. 1 for aid of reference. It will be understood, however, that the various methods of the invention may be practiced using devices and systems other than the system 20.

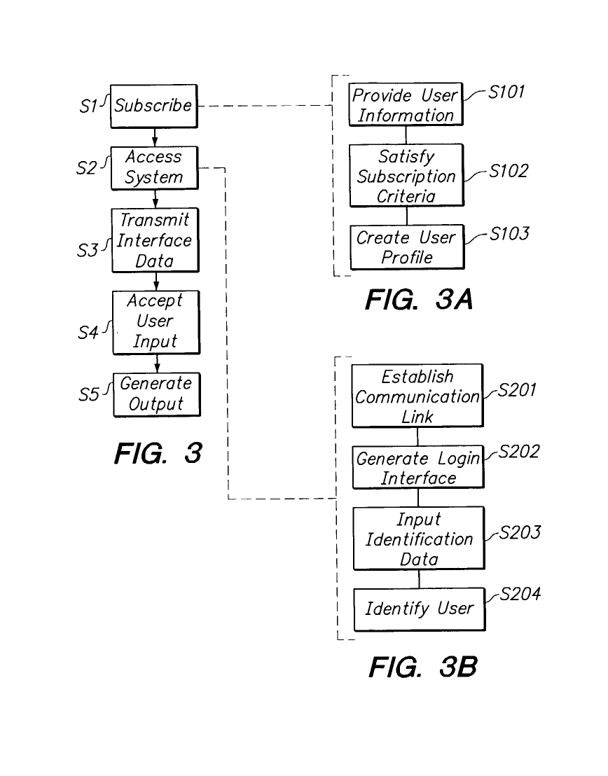

Referring to FIG. 3, in a first step S1 of a method, a user who desires to access the system may be required to sign up for access to the service. As illustrated in FIG. 3A, this step may comprise a plurality of individual steps. In one embodiment, a user is required to provide certain identifying information in a step S101. This information may comprise, for example, the name and address of the party, billing and other information. The information may be submitted on a written form. In one embodiment, the information may be submitted as part of execution of a required “subscription” form. The information, including the subscription form, may also be provided in electronic form. For example, a user may be permitted to access a portion of a website associated with the host 22 via a connection over the Internet 40.

In one embodiment, in a step S102, the user may be required to meet various criteria in order to be permitted to subscribe or access the system. In one embodiment, the criteria includes the payment of a fee. The fee may dependent on variety of circumstances, including the quantity of information or features of the system which the user desires to access. An up-front or “subscription fee” may be required to be paid, and/or monthly or “by use” fees may be required to be paid. In one embodiment, these fees may be paid in an electronic funds transaction. Such transactions are known and may comprise, for example, use of a credit card.

In a step S103, a profile or account is created for a user. In one embodiment, at least one file is generated corresponding to a user. This file may contain a variety of information, such as the submitted identification information and various transaction data which is generated later during use of the system by the user. In one embodiment, this file or information in other forms may be stored in a mass storage device, such as the device 26 of the host 22 of the system 20 illustrated in FIG. 1.

Referring again to FIG. 3, in one embodiment of the method, in a step S2, a user accesses the system. One embodiment of this step is illustrated in more detail in FIG. 3B. As illustrated therein, in a first step S201, a user establishes a communication link with the system. With respect to the system 20 illustrated in FIG. 1, this step may comprise a user accessing the host 22 via the Internet 40 or the LAN 38. In general, the user will access the system using their own computing device having a communication interface. For example, the user may access the system 20 using a remotely located desk-top computer, laptop or hand-held computing device. As indicated above, the user might also access the host 22 using one of the stations 39 directly part of the LAN 38.

In one embodiment, in a step S202, when the user accesses the system, a login screen or interface is generated and transmitted to the user requesting that the user provide identifying information. The login screen or interface may be generated, for example in the system 20 illustrated, by the host 22. In a step S203 the user inputs the requested information. This information may comprise, for example, a user identification code (user ID) and a password. These types of login processes and information are well known.

In a step S204, the user is identified using their login information. In one embodiment, the login information is compared to user information which is stored at the host 22, such as in the various user files. If the user is not identified, the user may not be permitted to access the system further and may be required to take other action, such as re-entering their information or seeking customer assistance.

Referring again to FIG. 3, once the user is identified, information is transmitted to the user in a step S3. In one embodiment of the invention, the information which is transmitted to the user comprises a graphical user interface. This interface may be generated, for example, by the host 22 of the system 20 illustrated in FIG. 1.

In a preferred embodiment of the invention, the information to which the user is permitted access, including the various functions and features of the system which the user may utilize, depends upon the status of the user. As indicated above, in one embodiment of the invention, users are classified into three main types: professional subscribers 54, business subscribers 56 and basic subscribers 58. In one embodiment of the invention, the graphical user interface which is transmitted to the user is customized depending upon the category or status of the user.

The graphical user interface may have a wide variety of formats. In one embodiment, the interface may have a main window or screen including a number of menus or similar items, such as icons, as well as other text and graphical information. The user may utilize the menu items or icons to implement functions or features, including causing other windows or screens of information to be displayed.

The menu items or icons may, for example, vary depending upon the status of the user. For example, particular menu items or icons associated with functions or features which are not accessible to certain users may be omitted. In another embodiment, the graphical user interface may be generally the same for all users, but functions or features to which certain users do not have access may not be activated.

Referring still to FIG. 3, in a step S4 input is accepted from a user. This input may comprise, for example, selection of a particular menu item or icon. The input may also comprise the input of specific information, such as in a text input box or the like. The various forms of input may depend upon the feature or function implemented.

In a step S5, an output is generated in response to an input. This output may comprise, for example, the generation of a new window of information or the generation of user specific information. This step may also comprise the steps of storing and/or transmitting the information.

A variety of the various functions and features which may be accomplished using the system, and forming the various input and output events of the method will now be described in more detail. As a primary aspect of the invention, the system and method are arranged to provide information to a user. Thus, one embodiment of the invention comprises providing general business information. As indicated above, the system may include a database of business information.

The business information may, as indicated with respect to the information database 42 illustrated in FIG. 1, comprise a wide variety of information. In a preferred embodiment, the information comprises tax and tax planning information. This information may comprise, for example, the U.S. Tax Code, various legal decisions, tax planning articles and decision diagrams and the like. The information preferably also includes other business strategy information, including corporate and other business entity formation strategy. Again, this information may comprise codes and other laws, as well as articles. The information may also comprise a wide variety of other business-related information such as employee hiring and termination information, safety and workplace compliance materials and the like.

In a preferred embodiment, the information which is provided includes information which specifically pertains to business strategies or activities for limiting the amount of taxes. For example, the information may comprise information regarding when or how to engage in certain acts or events to be engaged in the future by a business so that minimum tax liability or exposure is generated.

The information which is available may be derived from a variety of sources. In one embodiment, the materials may be generated, at least in part, by one or more users of the system, as described in more detail below. In other embodiments, the information may comprise “links” such as World Wide Web links to others' materials.

The information may also be arranged in a number of manners. For example, the information may be arranged by topic, date of creation or the like. In one embodiment, a user may utilize a search engine to search the information.

This information may be provided in a wide variety of formats. In one embodiment, the information may be provided in electronic form to a user. For example, requested information may be transmitted to a user for display on a display screen. In another embodiment, the user may download the information in electronic form for later viewing or printing. In another embodiment, as described in more detail below, a method of the invention comprises disseminating a printed or electronic newsletter containing information.

As another aspect of the invention, a user may be permitted to access a database of forms (such as the database 46 illustrated in FIG. 1). In a preferred embodiment, the forms database 46 contains one or more forms stored in electronic format. The forms are preferably business-related forms, such as tax forms and corporate compliance forms. For example, the forms may include an “annual list of corporate officers” form for filing with a Secretary of State.

In one embodiment, the forms may be downloaded in electronic form by an authorized user. In another embodiment, the forms may be printed. In a preferred embodiment, the forms are accessible through a particular graphical user interface which permits an authorized user to access the form and complete the form while accessing the system. In one embodiment, once the form is filled out, the user may either print the completed form or have the form stored electronically, as described in more detail below.

In one embodiment, a system of the invention may include a “forms module.” This module may comprise hardware or, more preferably, software for execution by the host 22. The module preferably serves as an interface permitting access to the forms. For example, the forms module may comprise software for generating the above-mentioned graphical user interface, accepting user input, inputting information into one or more of the forms, and storing, printing or transmitting the completed form, and otherwise implementing other functions related to the forms.

In a preferred embodiment, the records database 48 contains records belonging to one or more authorized clients. These records may be arranged as files. In one embodiment, the database 48 includes a plurality of folders, each folder associated with a particular client, and that folder containing other folders or files.

The records which are stored in the database 48 preferably comprise information stored in electronic form. The information may comprise a wide variety of business-related information. For example, the records may comprise tax records, such as electronic copies of tax returns. In one embodiment, the records comprise forms which were generated on-line by accessing the forms database 46.

The system may include a “records module” for providing access to the records database. In similar manner to a forms module, the records module may be arranged to generate a graphical user interface permitting a user to access stored records, modify records, generate records, store records and arrange stored records.

In one or more embodiments, the calendar database 50 includes electronic information regarding acts which may or must be taken by one or more users of the system or their clients. In a preferred embodiment, the information includes date information regarding dates by which those actions should or must be taken. This information may again be stored in files, folders or in other forms.

In one embodiment, as described below, a method comprises generating calendar or docketing information and storing that information in the calendar database 50. In one embodiment, referring to FIG. 2, the host 22 may be configured to run a docketing or calendaring program. This program may be configured to generate calendar or docket information and store it in the calendar database 50. The host 22 may also use this calendar information to generate electronic reminders and even generate compliance information, as described in more detail below.

In one embodiment, the system may include a “calendaring module.” Like the other modules described above, the calendaring module may be implemented as software running on the host. The module preferably serves as an interface. This interface may permit a user to input information regarding a particular act or event. In response, the module may be arranged to generate calendar events and then store that calendar information. The module may also utilize the calendar information to generate a reminder regarding an upcoming event and transmit that reminder to a user. The module may also facilitate a wide variety of other acts or functions.

As indicated above, in one embodiment there are classifications of users. Various methods of the invention, including access to particular features of a system of the invention, may be limited depending upon the classification or status of the user. As indicated, in one or more embodiments there are three classifications: the professional subscriber 54, the business subscriber 56 and the basic subscriber 58. There may be more than or less than this number of user classifications.

In one embodiment, the basic subscriber 58 has the most limited access to the system and the various features or functions thereof. In one embodiment, the basic subscriber 58 is permitted to only access the informational database 42 and to obtain business-related information. The basic subscriber 58 may be required to pay a subscription fee comprising an initial fee at the time the user signs up to utilize the system, as well as a monthly fee to continue to be permitted to access the system.

In one embodiment, the basic subscriber 58 is permitted to access the system and obtain, such as by downloading or printing, various of the information in the information database 42. The basic subscriber 58 is not permitted, however, to access the forms, records or calendaring databases or their associated features.

The second classification is the business subscriber 56. In one embodiment, the business subscriber 56 has access to a greater number of features of the system than the basic subscriber 58, but less access than the professional subscriber 54. In one embodiment, the business subscriber 56 is permitted to utilize and access the information database 42, forms database 46 and records database 48, and have calendaring or docketing information generated and stored in the calendaring database 50 and other wise use the forms, calendaring and related functions of the system.

Generally, the business subscriber 56 is a business or similar entity wishing to obtain business information, forms and obtain reminders for due dates and the like for its own use, the business subscriber 56 not providing these types of services for third parties. In one embodiment, the business subscriber 56 may also be required to pay a subscription fee, such as a one-time sign up fee as well as monthly dues or fees. These fees may be larger than those paid by a basic subscriber 58.

The third classification is the professional subscriber 54. In a preferred embodiment, the professional subscriber 54 has the highest level of access of all users, and generally has access to all of the features of the system which are available to users.

In one embodiment the professional subscriber 54 must, like the other users, may a fee for access to the system. This fee may again comprise a sign-up fee and a monthly subscription fee or the like.

In one embodiment, a professional subscriber 54 is generally a party that represents or provides business, such as tax and corporate strategy services, to third parties or clients. In one embodiment of the invention, the professional subscriber 54 must be certified in order to use the system for this purpose.

One embodiment of the invention comprises a method of certifying a user. In one embodiment, this method includes the step of a user or subscriber signing up or subscribing to use the system. As indicated, this may require payment of a fee. The method also includes the step of the user receiving training regarding how to use the system, as well as fundamental training regarding business strategy information including tax, corporate and other information. The user may be required to pass one or more tests, exams or the like in order to achieve certification. The user may also be required to perform certain acts to maintain their certification, such as taking a certain number of additional hours of training each year.

The training may be provided in a variety of manners. For example, the user may attend classroom training at a classroom 60 such as that illustrated as part of the system 20 illustrated in FIG. 1.

In one embodiment, if the user is certified, then they are entitled to utilize a title. This title is, in one embodiment, Certified Corporate Administrator.

Of course, there may be various features or components of the system which are not accessible to any of the users, but which are only accessible to the operator of the system. In one embodiment, a system of the invention may include a user identification module. This module may be arranged, for example, as software running on a host. The module may be arranged to generate a user profile based upon subscription information. This profile may include information regarding an assigned category or status of the user (such as basic, business or professional level subscriber), as well as the various portions of the system or business information functions which the user may be entitled to utilize based upon their category or status. As indicated, each category may be defined by the particular information or functions which are accessible. In another embodiment, the accessibility may be modified on a user-by-user basis. This module may be arranged to identify a user based upon input information, and from that information determine the user's profile including assigned category or status. As indicated, this information may be used, for example, to custom configure a graphical user interface which is transmitted to a user.

Various aspects of the systems and methods of the invention will now be described in more detail. In accordance with the invention, a party may obtain comprehensive business strategy information in a quantity and manner not currently existing. In accordance with the invention, a party may obtain information from a single source regarding a wide range of business strategies, including tax planning and corporate and other planning and strategic decisions.

In one embodiment, a user may access an information database and gain access to this information. The information may be provided to a user at a remote location by transmitting it in electronic form to them. As indicated above, this information may pertain to a wide variety of topics and may have a wide variety of sources.

In accordance with one embodiment of the invention, the accessible information includes information regarding professional lever users. As indicated, in one embodiment of the invention these users are certified to provide business strategy services to third parties or clients. In one embodiment, each professional level user is entitled to include information about themselves and their services via the information database. In this manner, other parties may obtain information about them and utilize this information in making a selection regarding the contracting of such services.

In one embodiment, the information regarding the professional level or certified subscribers may be accessible to even non-subscribing users. For example, as indicated above, at least one graphical user interface may be generated and displayed when a party accesses a web or domain address for the system. This graphical user interface may provide subscription and other information, permitting parties to subscribe to the system and services on-line from a remote location. The interface may also provide information regarding the professional level or certified subscribers. This information may alternatively be displayed in response to the selection of a menu item or the like. In one embodiment, a professional level subscriber's information may be displayed to interested parties at a “web” page.

As indicated, the information which is accessible to the users may be transmitted in electronic form, downloaded or the like. As one aspect of the invention, the system includes a printer and the method includes the step of generating a newsletter. This newsletter may contain a wide variety of business strategy information, including information regarding recent changes to the law, recent court decisions, and articles regarding tax and corporate strategies, among other things.

With reference to the system 20 illustrated in FIG. 1, this newsletter may be printed using the printer 31. Of course, the newsletter may be generated by other means. The newsletter may also be transmitted in electronic form.

In any event, the newsletter is preferably disseminated at regular intervals, such as monthly. In one embodiment of the invention, the newsletter may be disseminated to each subscribing user of the system. In one embodiment, a professional level subscriber may cause the newsletter to be directed to each of their clients or prospective clients.

An authorized user (such as a business or professional level subscriber in the embodiment described above) may be permitted to access and generate forms, as well as store records. For example, a corporation may utilize the forms database to generate required forms for filing with the Secretary of State or IRS. Once completed, these forms may be stored in electronic form in the records database.

An authorized user (such as business or professional level subscriber in the embodiment described above) may be permitted to utilize a calendaring function of the system. Utilizing the calendaring system, the user may be provided reminders that certain actions should or must be taken. For example, dates may

In one embodiment, the calendaring function may be utilized through an interface which is displayed to the user. For example, the interface may include various text input boxes, menu selections and the like for inputting data causing calendar dates to be generated.

In one embodiment, in response to a calendar date, if appropriate, an electronic form may be generated. For example, with respect to the system 20 illustrated in FIG. 1, a calendaring program executed by the host 22 may cause the host 22 to seek an electronic form from the forms database 46. The host 22 may utilize data from a record of information for the particular client or user and fill appropriate information into the form, and then print or electronically transmit the form. For example, after completing, the form may be transmitted in electronic form directly to another entity, such as the Secretary of State. The completed form in electronic format may also then be filed in the user or client's record in the records database 48.

In one embodiment of the invention, a charge or fee may be applied for the generation of particular forms, the calendaring function or the like. In a preferred embodiment, each user who wishes to create a records file for the storage and maintaining of information in the calendaring system must pay a subscriber fee. This fee may be a one time or recurring, such as monthly, fee. For example, a business subscriber may be obligated to pay a fee separate from their subscription fee in order to have a data record created and have their pertinent information calendared. A professional level subscriber may be required to pay such a fee for each individual client they represent and wish to incorporate into the system.

In one embodiment of the invention, users of the system may author articles and other information and associate that information with the system for access by other users. For example, a professional level subscriber may wish to author an article about a particular tax strategy. The user may transmit this article to the operator of the system and have the article placed in the information database for access by others. Appropriate credit may be attributed to the author in order to aid the author in obtaining the business of clients.

As indicated, in one embodiment of the system, such as that illustrated in FIG. 1, the system includes a classroom 60. The classroom 60 may be used to train users of the system regarding how to access and use the system, as well as offer education on particular topics of business strategy. The classroom 60 may include one or more stations 39 or similar points of access to the host 22. In this manner, an instructor may navigate students through the use of the system 20 in real-time, showing them the various features and functions thereof.

In one embodiment, as described, the classroom 60 may be used to provide in-depth training regarding particular business strategy and related topics. For example, the classroom 60 may be used to provide education regarding changes in the tax code. The classroom training may be used to supplement the information which is accessible on the system. For example, the classroom may provide a greater depth of analysis of particular information located on the system. After the training, the users may access this information for future reference.

The various methods and systems of the invention have numerous benefits and advantages. Generally, the invention is a system and method which, for the first time, assembles in a single source a number of presently distinct elements. In accordance with the invention, a method and system provide comprehensive business strategy and compliance information. This information includes tracking or calendaring of dates by which actions need to be taken. The information comprises electronic records of business-related documents. The information 150 comprises general business strategy information, such as choice of business entity, tax planning and preparation and other information.

The system of the invention provides this information to users over a global computer network, such as by access through the Internet, allowing the user to obtain information and other wise utilize the functionality of the system at all times. No longer, for example, does a business need to wait until working hours to access their business records from a corporate attorney. Instead, the business may simply access their records at the records database.

The system provides a mechanism for teaching. The system permits users to learn business strategy by accessing an information database. Users may also enroll in classroom training to learn about specific topics.

The invention provides for an entirely new class of personnel: Certified Corporate Administrators. These personnel are specifically trained regarding comprehensive aspects of business strategy, including not just tax and accounting issues, but corporate and related issues. Further, these personnel are trained to utilize the system so that they stay abreast of recent changes in the laws and newly developed strategies. The personnel are also trained to utilize the system to generate necessary forms, store records and track dates by which actions must be taken.

One aspect of the invention is a system which permits lients to learn about personnel who are knowledgeable about business strategy issues and then seek their services. As indicated, professional level subscribers may post information about themselves and author articles or other information accessible to prospective clients. The prospective clients may learn of these professionals and then hire them to have them provide business strategy information, maintain their corporate records and the like.

One aspect of a system and method of the invention is that it provides for different levels of users. In this arrangement, the specific needs and requirements of the different types of users are specifically addressed, including with regard to pricing structure.

An advantage of the method and system of the invention is that information and services previously not available are now available to a wide range of entities. For example, a small business which previously could afford to utilize an accountant and a separate corporate lawyer may now access, at a much reduced cost, information which would originally have been provided by both of these independent, more expensive resources.

One aspect of the system and method is that professionals, such as accountants and lawyers, also have a great source of information and features which they can offer their clients. These professionals have the advantage over others not using the system that they have access from a single source of much more comprehensive information, and at a low cost. Further, these professionals have a single source by which they can offer electronic record keeping, calendaring, and related functions.

As one aspect of the invention, the process for providing and generating forms related to business activity, such as forms necessary for corporate compliance and tax filings, is greatly streamlined. Once again, this saves money for the end user, including by way of tax reduction or relief achieved by utilizing the information and employing proper planning and strategy.

It will be understood that the above described arrangements of apparatus and the method therefrom are merely illustrative of applications of the principles of this invention and many other embodiments and modifications may be made without departing from the spirit and scope of the invention as defined in the claims.

What is claimed is:

1. A business information system for providing business strategy and related information to a plurality of users comprising:
a host, said host comprising at least one computing device configured to execute machine readable code to perform various functions;
an information database associated with said host, said information database containing business strategy information associated with said host;
a records database associated with said host, said records database containing business records in electronic format;
a forms database associated with said host; said forms database containing forms in electronic format;
a calendaring module associated with said host for generating calendar dates and reminders regarding calendar dates;
a calendaring database associated with said host, said calendaring database containing calendaring data;
a user identification module associated with said host for use in identifying a user and a status of said user, said status of said user determining said user's access to portions of said system; and
a communication interface associated with said host permitting information to be received by said host from a remotely located user via a communication link and permitting information to be transmitted from said host to said user.

2. The system in accordance with claim 1 including at least one workstation from which a user may access said host.

3. The system in accordance with claim 1 wherein said workstation is located at a classroom.

4. The system in accordance with claim 1 including a printing device associated with said host for printing forms from said forms database.

5. The system in accordance with claim 1 including a forms module for presenting a form from said forms database, accepting input of information, and inputting said information into said form for completing said form.

6. The system in accordance with claim 1 including a records module for accessing records in said records database and generating new records and storing them in said records database.

7. The system in accordance with claim 1 including a graphical user interface, said graphical user interface generated by said host and transmitted to said user for utilizing said system.

8. The system in accordance with claim 7 wherein a format of said graphical user interface is dependent upon a status of said user.

9. The system in accordance with claim 1 wherein said information, records, forms and calendaring databases are all part of a common data mass storage device.

10. The system in accordance with claim 1 wherein said business strategy information pertains to tax and corporate planning topics.

11. A method of providing business information to a plurality of users comprising:
providing a computer system including a host for receiving and transmitting information, said host capable of implementing a plurality of business information functions selected from the group consisting of providing business strategy information, storing electronic records, generating forms and generating calendar dates;
assigning a user to one of a plurality of user categories, each user category defining one or more of the plurality of business information functions to which said user has access, one or more of said user categories not permitting access to all of said business information functions;
receiving user identification information from a user desiring to use the system;
determining the user category assigned to said user; and
permitting said user to utilize said business information functions defined by said user category to which said user is assigned.

12. The method in accordance with claim 11 wherein there are three user categories.

13. The method in accordance with claim 11 including the step of generating a printed newsletter containing business strategy information and disseminating said newsletter to one or more of said users or clients identified by said users.

14. The method in accordance with claim 11 including the step of providing a records database as part of said system and storing one or more business records belonging to said user or a user's client in said records database.

15. The method in accordance with claim 11 including the step of providing a forms database containing one or more forms in electronic format, and permitting said user to access a form in said database.

16. The method in accordance with claim 15 including the step of accepting user input of form information and inputting said information into said form to complete said form.

17. The method in accordance with claim 11 including the step of accepting input from said user regarding one or more events, generating calendar information regarding an event from said input, storing said calendar information, and generating a reminder regarding said event and transmitting said reminder to said user.

18. A method of providing business strategy and related business information to a party comprising:
providing live classroom training to said user to educate the party regarding business strategy information in the areas of tax and business entity planning;
providing said party with business strategy information from an electronic database of stored information;
providing forms in electronic format for access by said party;
storing records in electronic format for said party;
generating calendar dates and providing calendar reminders to said party; and
providing said party with a newsletter containing information regarding business strategy information.

19. The method in accordance with claim 18 including the step of certifying said party to be a certified user, said certification requiring said party to complete a number of hours of said live classroom training and compliance with additional criteria.

20. The method in accordance with claim 19 including the step of generating information regarding certified users and providing said information to other parties.

21. The method in accordance with claim 18 including the step of accepting input from a party and associating said information with one of said forms in electronic format.

22. The method in accordance with claim 18 including the step of accepting input from a party regarding an activity and generating said calendar dates in response to said input.

23. The method in accordance with claim 18 including the step of associating said party with a particular user category and providing information to said party based upon their assigned user category.
